(19) United States
(12) Patent Application Publication
(10) Pub. No.: US 2016/0240340 A1
(43) Pub. Date: Aug. 18, 2016

(54) THERMAL CIRCUIT BREAKER

(71) Applicant: Mechanical Products Company, Lombard, IL (US)

(72) Inventors: Brian Lamerdin, Glenview, IL (US); Cuong Ha, Lincolnwood, IL (US); Robert Holmes, Summit Township, MI (US); Ronald Prokup, Lake Barrington, IL (US)

(21) Appl. No.: 15/046,159

(22) Filed: Feb. 17, 2016

Related U.S. Application Data
(60) Provisional application No. 62/117,780, filed on Feb. 18, 2015.

(51) Int. Cl. H01H 61/06

(52) U.S. Cl. CPC H01H 61/063; H01H 2205/002; H01H 2219/054

(57) ABSTRACT

An electric current responsive circuit breaker device includes a housing formed from electrically insulating material and the housing has an internal compartment and an open end. The circuit breaker further includes a thermostatic snap-action blade and first and second electrically conductive contacts such that the first contact has a stationary position disposed within the internal compartment and the second contact is disposed on the thermostatic snap-action blade. Further, the first and second contacts are coupled such that electric current flows through the contacts when the temperature of the thermostatic snap-action blade is below a threshold level, and the thermostatic snap-action blade bends to uncouple the second contact from the first contact when the temperature of the thermostatic snap-action blade is at or above the threshold level so that electric current does not flow through the first and second contacts after the first and second contacts are uncoupled. The circuit breaker device further includes a flexible gasket and a cover interconnectedly arranged with the open end of the housing such that the flexible gasket is arranged between the cover and the housing, and the gasket has a throughhole disposed on an interior portion thereof.

### CROSS REFERENCE TO RELATED APPLICATIONS

The present application claims the benefit of Lamerdin et al., U.S. provisional patent application Ser. No. 62/117,780, filed on Feb. 18, 2015, and entitled “Thermal Circuit Breaker.” The entire contents of this application are incorporated herein by reference.

### REFERENCE REGARDING FEDERALLY SPONSORED RESEARCH OR DEVELOPMENT

Not applicable

### SEQUENTIAL LISTING

Not applicable

### FIELD OF DISCLOSURE

The present subject matter relates to electrical circuit breakers, and more particularly to circuit breakers using snap-action thermostatic discs, which allow for illuminated trip indication.

### BACKGROUND

In a typical autoreset snap-action thermal circuit protector, a curved or cupped, current carrying, thermostatic blade is mounted in a housing so that the blade can snap between two oppositely cupped configurations in which the contacts are closed or the contacts are open, depending on the temperature of the blade. With the contacts closed, electrical current through the blade above a predefined level and duration generates heat, which raises the temperature of the blade to a point at which the blade will snap into a configuration having the contacts open, thereby breaking the electrical circuit. As the blade cools off to a lower reset temperature, the thermostatic blade will automatically snap back to a configuration having the contacts closed and thereby re-establishing electrical continuity in the circuit.

Typical manually resettable circuit breakers employ a similar cupped thermostatic blade having a relatively low reset temperature. Such manually resettable circuit breakers may require the use of a reset plate and associated components to apply a force to the blade to cause the blade to reset to a contacts-closed position. The reset plate and associated components assist a user in applying a relatively high force to the blade without interfering with trip-free operation. Trip-free operation refers to the quality of the contacts being allowed to open even if the reset mechanism is held in the actuated position. The inclusion of a reset plate results in a relatively complex configuration of components in such circuit breakers. In addition, thermostatic blades with wide temperature differentials are complex to manufacture. Further, automatically resettable thermostatic blades may use a relatively narrow temperature differential between the contacts-open position and the contacts-closed (reset) position.

Manually resettable circuit breakers do not always include an external indication of the position of the contacts, either open or closed. The position of an external reset actuator mechanism (such as a reset button) may be the same regardless of the status of the circuit breaker contacts or the energization of the electrical circuit. Mechanical external reset actuators that do indicate the status of the contacts may not be visible under low light conditions and do not always indicate the energization status of the circuit. Therefore, when a user views a typical circuit breaker that does not have an external indication of the position of the contacts, the user is not able to perceive whether or not the main circuit is electrically “hot.”

However, in the case of a circuit breaker having a light for indicating status, a user may perceive whether the breaker is tripped open when the light is illuminated. Furthermore, if the light remains unlit then the circuit is not electrically “hot.” Further, if the breaker is in the closed position, the light will always be unlit and will impart no information regarding the “on” or “off” status of the circuit. Other types of manually resettable circuit breakers may employ an automatically resettable thermostatic blade along with a spring loaded, insulating flag. The spring loaded, insulating flag rotates between the contacts when the contacts are opened and prevents the re-closing of the contacts. The circuit breaker may be manually reset by rotating a lever attached to the spring-loaded flag that then removes the flag from between the contacts, allowing the contacts to close.

When using a manually resettable circuit breaker with a spring loaded, insulating flag, the insulating member may drag across the contacts. The dragging motion of the insulating flag may deteriorate or contaminate the contacts during repeated cycling when using this type of circuit breaker. For these and other reasons a trip free, automatic or manually resettable thermal circuit breaker that provides an improved seal and/or indication of circuit breaker status would be an improvement in the art.

### SUMMARY

According to one aspect, an electric current responsive circuit breaker device includes a housing formed from electrically insulating material and the housing has an internal compartment and an open end. The circuit breaker further includes a thermostatic snap-action blade and first and second electrically conductive contacts such that the first contact has a stationary position disposed within the internal compartment and the second contact is disposed on the thermostatic snap-action blade. Further, the first and second contacts are coupled such that electric current flows through the contacts when the temperature of the thermostatic snap-action blade is below a threshold level, and the thermostatic snap-action blade bends to uncouple the second contact from the first contact when the temperature of the thermostatic snap-action blade is at or above the threshold level so that electric current does not flow through the first and second contacts after the first and second contacts are uncoupled. The circuit breaker device further includes a flexible gasket and a cover interconnectedly arranged with the open end of the housing such that the flexible gasket is arranged between the cover and the housing, and the gasket has a throughhole disposed on an interior portion thereof.

According to another aspect, a thermally responsive circuit breaker device includes a housing formed from electrically insulating material, the housing having an internal compartment, a bottom wall, and a plurality of sidewalls. Further, the circuit breaker device includes first and second electrically conductive contacts and a thermostatic snap-action blade, such that the first electrically conductive contact is disposed on the bottom wall of the housing and the second electrically conductive contact is disposed on the thermostatic snap-action blade. The blade of the circuit breaker has first and second positions such that in the first position, the first and second contacts are coupled so that electricity is conducted, and in the second position, the first and second contacts are uncoupled so that electricity is not conducted. Further still, the thermostatic snap-action blade is in the first position when the blade has a temperature below a threshold level, and the blade snaps to the second position in response to the temperature rising above the threshold level. The circuit breaker device further includes a raised area and a flexible gasket having an interior flange such that the interior flange surrounds at least a portion of the raised area and is fixedly attached thereto.

### BRIEF DESCRIPTION OF THE DRAWINGS

FIG. 1 is a cross-sectional view of a manually resettable circuit breaker shown with contacts in a closed position;

FIG. 2 is a cross-sectional view of the manually resettable circuit breaker of FIG. 1 shown with the contacts in an open position;

FIG. 3 is a cross-sectional view of the manually resettable circuit breaker of FIG. 1 shown with a manual reset button depressed;

FIG. 4 is a cross-sectional view of an alternative embodiment of a manually resettable circuit breaker of FIG. 1 with contacts in a closed position and having a lighted status indication circuit shown in a non-operating (unlighted) mode;

FIG. 5 is a cross-sectional view of the manually resettable circuit breaker of FIG. 4 with the contacts in an open position and having the lighted status indication circuit in the operating (lighted) mode;

FIG. 6 is a cross-sectional view of an automatically resettable circuit breaker shown with contacts in a closed position;

FIG. 6A is a cross-sectional view of the automatically resettable circuit breaker of FIG. 6 shown with the contacts in an open position;

FIG. 7 is an isometric view of a manual reset lever;

FIG. 8 is a top isometric view of a flexible gasket having a flanged hole for use with the manually resettable circuit breakers seen in FIGS. 1-5;

FIG. 9 is a front view of a lighted status indication circuit for use with the manually resettable circuit breaker of FIGS. 4 and 5;

FIG. 10 is a cross-sectional view of another embodiment of an automatically resettable circuit breaker with contacts in a closed position and having a lighted status indication circuit in a non-operating (unlighted) mode;

FIG. 11 is a cross-sectional view of the embodiment of the automatically resettable circuit breaker of FIG. 10 with contacts in an open position and having the lighted status indication circuit in an operating (lighted) mode;

FIG. 12 is an isometric view of an embodiment of a manually resettable circuit breaker; and

FIG. 13 is an isometric view of an embodiment of a housing for a manually resettable circuit breaker with a cover removed.

### DETAILED DESCRIPTION

As seen herein a circuit breaker using a current carrying thermostatic, snap-action blade is shown and described. Various embodiments of the circuit breaker employ an improved flexible seal used with a non-rotational reset button. The circuit breaker may selectively include a lighted indication device to visually provide the state of the electrical circuit and contacts.

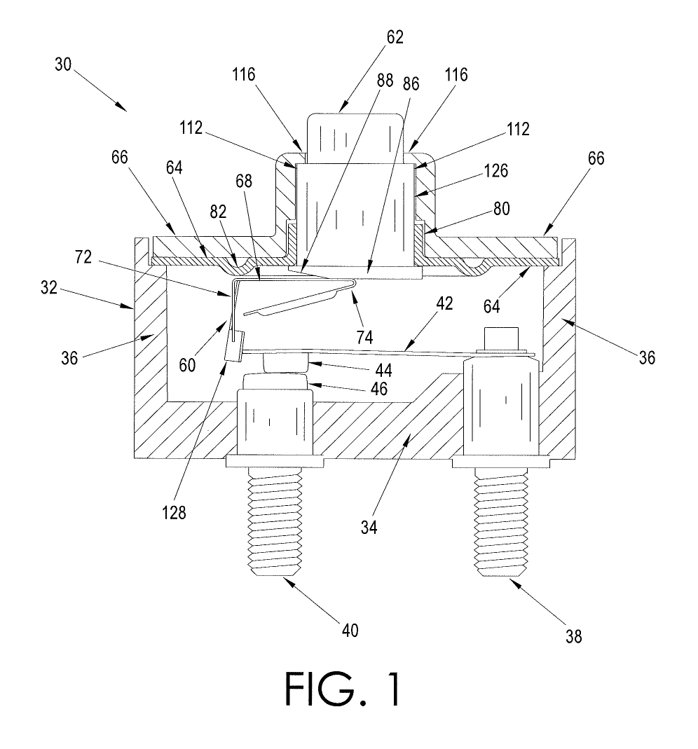

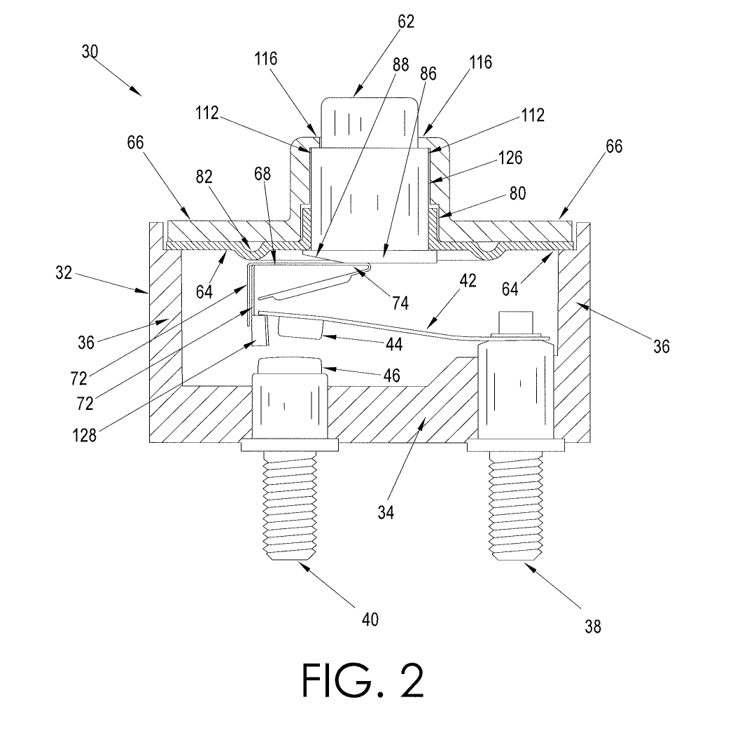

Referring now to FIG. 1, a manually resettable circuit breaker 30 is shown. The manually resettable circuit breaker 30 in this embodiment has a generally cup-shaped housing 32 molded of electrically insulating material, having a bottom wall 34 and four sidewalls 36 encompassing a volume and forming an open-ended, roughly rectangular internal compartment. The generally cup-shaped housing may be molded from an electrically insulating material such as plastic or another suitable electrically insulating material. Two electrical terminals 38 and 40 pass through the bottom wall 34 of the housing 32. A cupped thermostatic, snap-action blade 42 is attached as a cantilever to terminal 38 with a movable electrical contact 44 attached to the free end of the blade. The snap-action blade 42 is able to move into and out of engagement with a stationary electrical contact 46 mounted on terminal 40. The thermostatic, snap-action blade 42 may be formed into a cupped configuration such that the blade 42 will snap between a generally downward concave shape as shown in FIG. 1 and a generally upward concave shape as shown in FIG. 2 depending on the temperature of the blade 42.

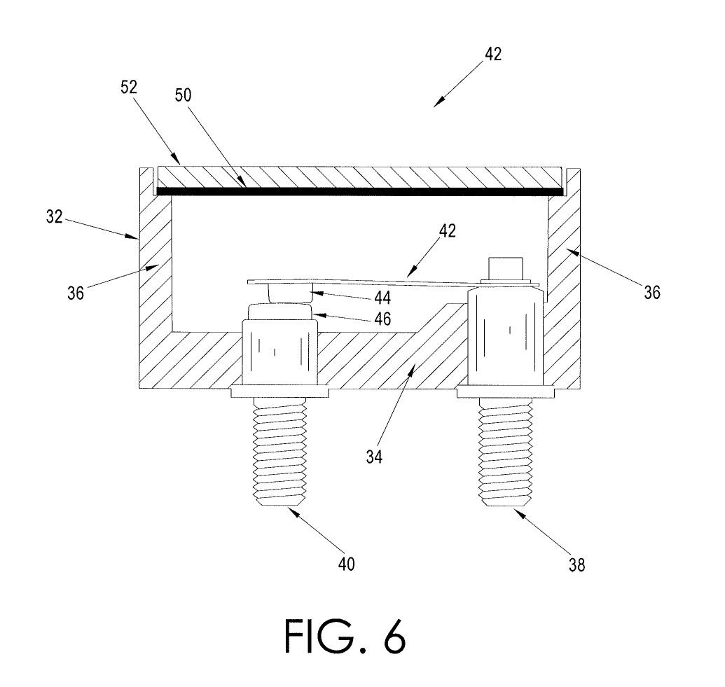

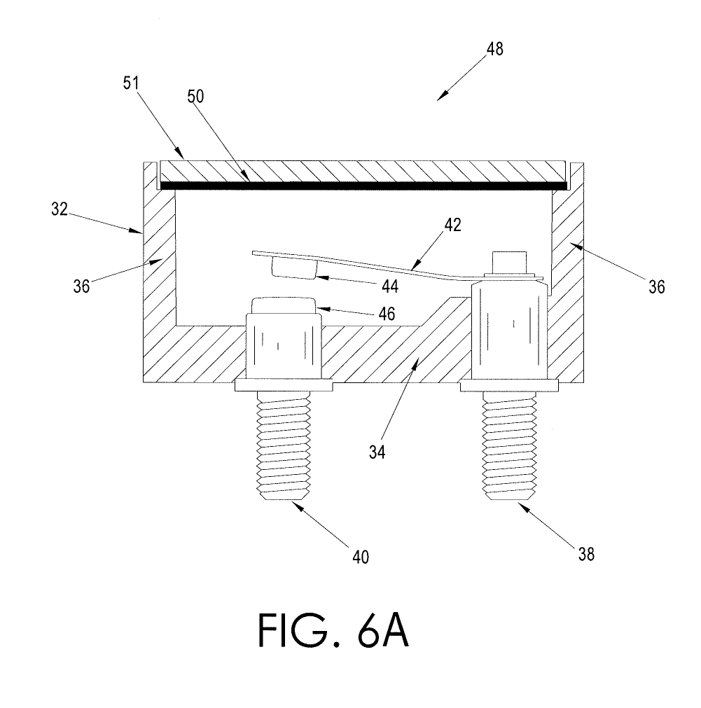

In another example embodiment, an automatically resettable circuit breaker 48 as seen in FIG. 6 may be provided. In this example, the snap-action blade 42 of the automatically resettable circuit breaker 48 may be formed such that blade 42 snaps from a first, contacts-engaged (closed) position, as shown in FIG. 6, to a second, contacts-disengaged (open) position, as shown in FIG. 6A, upon the blade 42 reaching a preselected threshold temperature. The thermostatic blade 42 may then snap back to the first, contacts-closed position (FIG. 6) upon cooling to a lower preselected threshold temperature. As seen in FIGS. 6 and 6A, the automatically resettable circuit breaker 48 may also be provided with an environmental seal in the form of a flexible gasket 50, which extends over a top portion of the open-ended housing 32. The flexible gasket 50 may be captured by a cover 52 attached to the housing 32 by rivets, for example, or any other suitable attachment means.

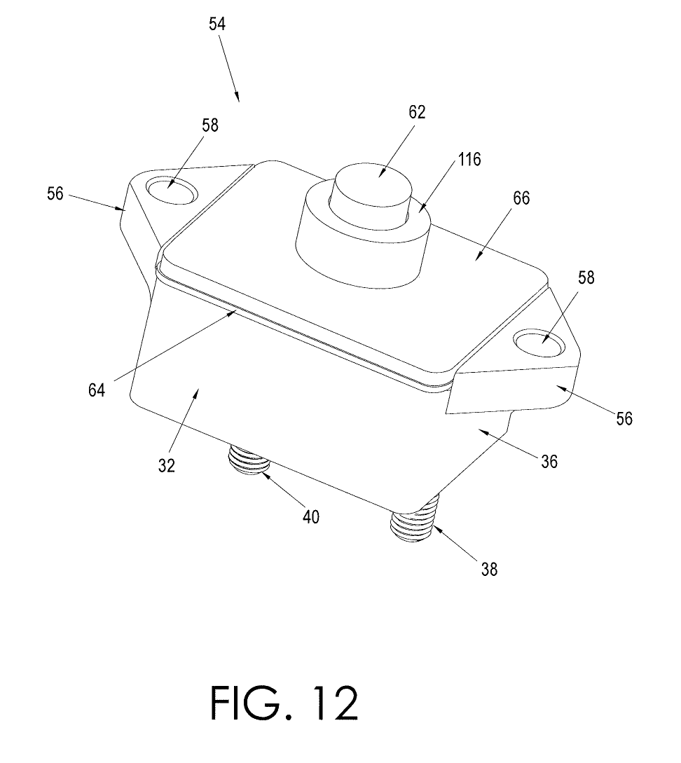

Referring ahead to FIG. 12, another example embodiment of a manually resettable circuit breaker 54 is shown. In this example embodiment, two mounting flanges 56 protrude laterally from opposing sidewalls 36 and the mounting flanges 56 are provided with mounting through holes 58.

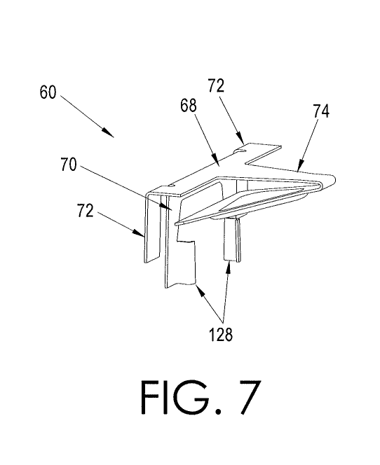

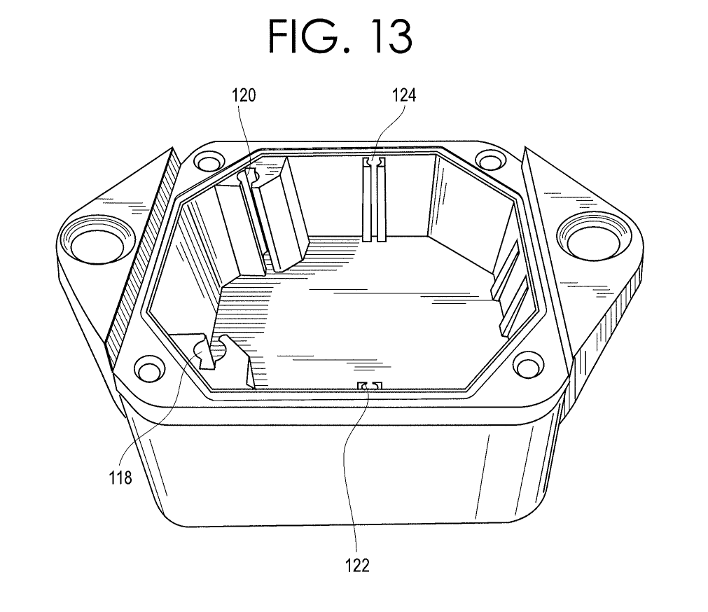

Referring back to FIG. 1, the manually resettable circuit breaker 30, in this embodiment, has a reset feature that includes manual reset lever 60, reset button 62, and corresponding interconnectedly arranged flexible gasket 64 and cover 66. Referring to FIG. 7, the manual reset lever 60 in this example is formed from a suitable resilient spring material, such as a 300 series stainless steel or another metal sheet with good spring action. As seen in FIG. 7, the manual reset lever 60 has a horizontal rectangular base 68, several legs 70 and 72 extending generally perpendicularly from the horizontal base 68. Flexible leg 74 extends generally laterally from the horizontal base 68 and is generally perpendicular to the length of the horizontal base 68. The flexible leg 74 is also bent at an acute angle back toward the base 68. Legs 70 are each provided with a tab 128 adjacent to and extending in a generally perpendicular direction from the free distal ends. Legs 72 are positioned on and extend downwardly from the distal ends of base 68. Legs 72 are held upright within slots 118, 120 (see FIG. 13) formed in the opposite sidewalls 36 of housing 32.

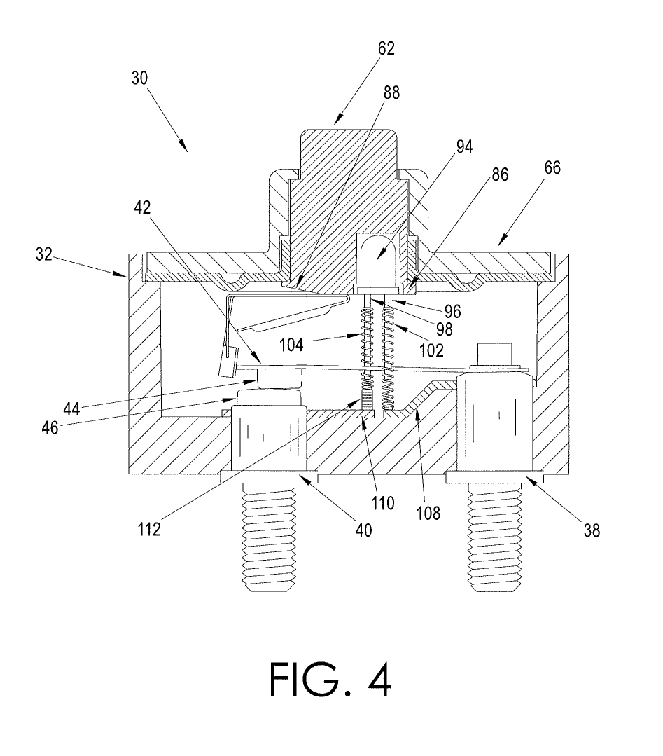

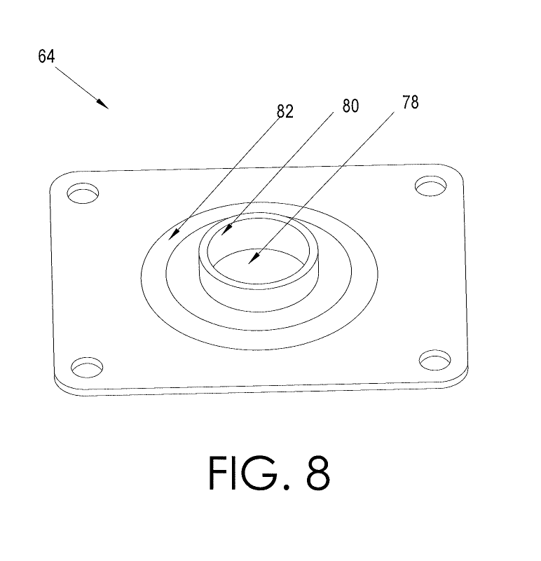

Referring to FIG. 8, flexible gasket 64 is provided with an interior flanged throughhole 78 positioned centrally at the gasket 64 to provide an environmental seal in the manually resettable circuit breaker 30, FIGS. 1-5. Flanged throughhole 78 of gasket 64, FIG. 8, allows the generally cylindrical reset button 62, FIGS. 1-5, to penetrate the gasket 64 by way of the flanged throughhole 78. The generally cylindrical reset button 62 may be formed of an electrically insulting material, such as thermoplastic, thermoset plastic, or another polymer, and such material may be opaque, translucent, or transparent. The gasket 64 may be held firmly on button outer diameter 112, FIGS. 1-5, by formed flexible flange 80 integral to the inner diameter of the flanged gasket throughhole 78, FIG. 8. With this configuration, circuitry providing lighted circuit breaker status indication, described with reference to FIGS. 4, 5 and 9, is able to penetrate the gasket 64 and be installed within reset button 62 by way of the gasket throughhole 78. This configuration not only allows circuitry for providing lighted circuit breaker status indication to penetrate the gasket, but also provides an exceptional environmental seal. The interface between the gasket 64 and the button outer diameter 112 produced by flexible flange 80 may provide a superior environmental seal as compared to previous gasket designs. Additionally, the combination of the non-rotational action of the cylindrical reset button 62 with the flexible flange 80 coupling the gasket 64 to the button outer diameter 112 provides for an advantageous environmental seal.

Gasket 64, FIGS. 1-5, also extends over the open end of housing 32 and is captured by circuit breaker cover 66 having an interior, centrally located upwardly flanged throughhole 126 with spray shielding lip 116 around the top inner diameter and accommodating reset button 62. The cover 66 may be attached to the housing by any suitable means, such as rivets. The inner diameter of lip 116 of cover 66 is smaller than the larger external diameter 112 of reset button 62. Therefore, the larger external diameter 112 of reset button 62 is enclosed by upwardly flanged cover throughhole 126. The lip 116 retains the button 62, preventing the reset button 62 from springing or falling out of the upwardly flanged cover throughhole 126 when the button 62 moves axially through said hole 126. The lip 116 further provides additional environmental shielding against high-pressure spray.

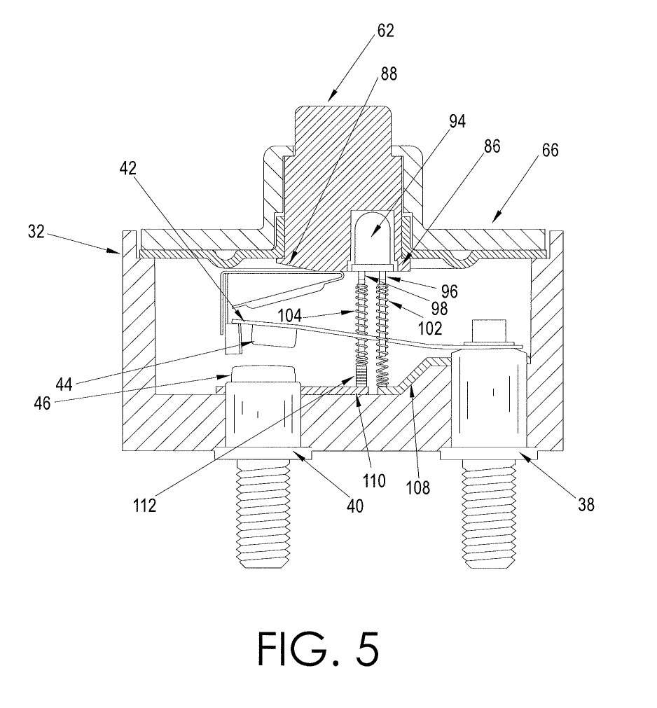

As shown in FIG. 4, the manually resettable circuit breaker 30 may provide externally illuminated trip indication through employment of a light source 94 such as a bi-directional LED, or another suitable light source such as an incandescent or neon light source. The light source 94, in this example, is housed within the reset button 62, wherein the reset button 62 may be formed of a transparent or translucent material. The housing of the light source 94 within the reset button 62 is made possible by the improved design of the gasket 64. The flexible flanges 80 and the improved environmental seal provided thereby, while allowing the reset button 62 to penetrate the gasket 64, further allow the light source 94 to be housed within the body of the reset button 62 itself. Housing the light source 94 within the reset button 62 allows for increased visibility of the light source 94 and improved operation of the manually resettable circuit breaker 30 having externally illuminated trip indication. Light source 94 is kept in electrical contact with terminals 38 and 40 through an electrical circuit formed by light source leads 96, springs 102, 104, and terminal leads 106 not in direct contact with blade 42, as seen in FIGS. 4 and 5. The electrical circuit formed may also include an additional resistor 112 selectively positionable within the circuit 84 to regulate the current through the light source 94.

FIG. 13 shows the manually resettable circuit breaker 30 with the cover 19 removed. The slots 118, 120 for holding the legs 72 in place are arranged on opposing sidewalls 36. In the embodiment shown, the slots 118, 120 are on one end of the opposing sidewalls 36, but may be arranged elsewhere along a length of the sidewalls 36. Further depicted in FIG. 13 are spring slots 122, 124 for holding the springs 102, 104 in place. The spring slots 122, 124 are arranged along opposing sidewalls 36 similar to the slots 118, 120. In the embodiment depicted here, the spring slots 122, 124 are near the middle of each opposing sidewall 36, although the spring slots 122, 124 may be arranged elsewhere along a length of the sidewalls 36. Both the slots 118, 120 and the spring slots 122, 124 may be disposed on either pair of opposing sidewalls 36 or on adjacent sidewalls 36. Alternatively, the slots 118, 120 and the spring slots 122, 124 may be disposed on only one of the sidewalls 36.

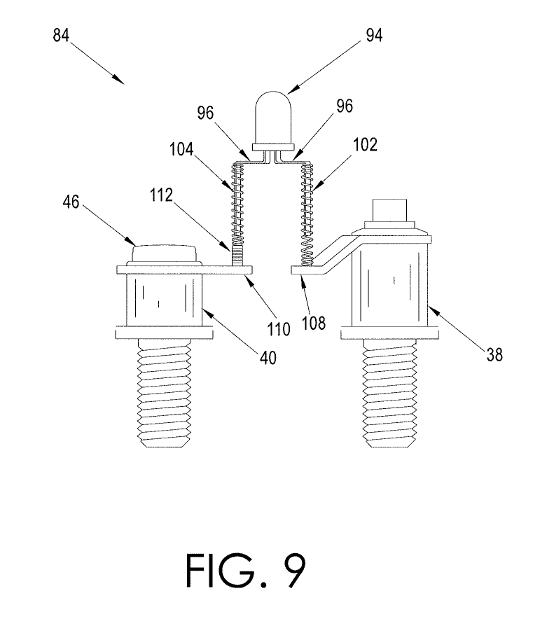

As shown in FIG. 1, blade 42 is in the first, contacts-closed position with tabs 128 against the edge of the blade. When the temperature of the blade 42 reaches the preselected snap threshold temperature created by Joule heating due to a current overload of a prescribed level and duration, the blade will snap to the second, contacts-open position shown in FIG. 2. When the thermostatic blade 42 snaps to the open position, FIG. 2, the resilient spring forces of the manual reset lever 60 will cause the tabs 128 to rotate under the edge of the blade 42, keeping the contacts in the open position after the blade 42 cools down and attempts to snap back to its first, contacts-closed position. When manually resettable circuit breaker 30 is in the second, contacts-open position, as seen in FIG. 5, an increase in voltage drop between the open contacts 44, 46 allows a small electrical current to pass in either direction between terminal 38 and terminal 40 through the lighted status indication circuit 84 as shown in FIG. 9. In this example embodiment, the lighted status indication circuit 84, as seen in FIG. 9, is formed by the electrical coupling of terminal 38, first terminal lead 108, first spring 102, first light source lead 96, light source 94, second light source lead 98, second spring 104, resistor 112, second terminal lead 110, and terminal 40. The electrical current resulting from the voltage drop enables the light source 94 to be visibly illuminated within the transparent or translucent reset button 62 thereby providing lighted indication of the trip at the circuit breaker 30 so long as sufficient supply voltage is applied to terminals 38 and 40. Some current always passes through the circuit powering the light source 94 regardless of the open or closed status of the contacts because the circuit powering the light source 94 is in parallel with the bimetal and contacts circuit. The voltage across the open contacts will be dependent on the voltage of the main circuit. For example, a typical open circuit supply voltage for the main circuit is from about 10 V to 50 V. In a further example, the light source 94 will be visibly illuminated at a typical open circuit supply voltage for the main circuit of approximately 15 V with a current of approximately 0.13 milliamperes through the lighted status indication circuit.

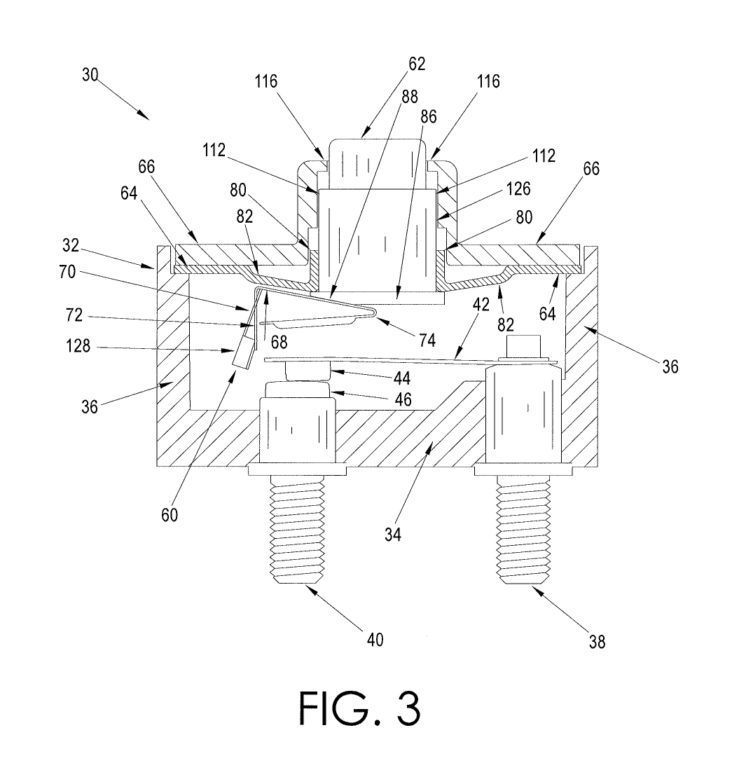

To reset the manually resettable circuit breaker 30, reset button 62 is depressed as shown in FIG. 3, causing gasket flange 80 to flex gasket 64 so that the button 62 presses on leg 74 of reset lever 60 through gasket throughhole 78. When the reset button 62 presses on leg 74, the lever 60 rotates against the spring force provided by legs 72, held within the slots 118, 120 (See FIG. 13) of housing 32, and forcing distal end of leg 74 to move legs 70 and slide tabs 128 out from underneath the blade 42. As seen in FIG. 3, when slide tabs 128 move out from underneath the blade 42, the blade 42 is allowed to snap back into the first, contacts-closed position. Subsequent release of reset button 62 allows the spring force of reset lever 60 and gasket 64 on the reset button 62 to return the circuit breaker 30 to the position shown in FIG. 1. To reset the manually resettable circuit breaker 30, reset button 62 is depressed as shown in FIG. 3, causing gasket flange 80 to flex gasket 64 so that the button 62 presses on leg 74 of reset lever 60 through gasket hole 78. When the reset button 62 presses on leg 74, the lever 60 rotates against the spring force provided by legs 72, held within the slots 118, 120 (See FIG. 13) of housing 32, and forcing distal end of leg 74 to move legs 70 and slide tabs 128 out from underneath the blade 42. If the lighted status indication circuit 84 is present, then as reset button 62 is depressed the light source 94 and light source lead 96, 98 move with the reset button 62, compressing the springs 102, 104. As seen in FIG. 3, when slide tabs 128 move out from underneath the blade 42, the blade 42 is allowed to snap back into the first, contacts-closed position. Subsequent release of reset button 62 allows the spring force of reset lever 60 and gasket 64 on the reset button 62 to return the circuit breaker 30 to the position shown in FIG. 1.

The reset button 62, in this example, may further include a bottom lip 86 and contacting surface 88 as shown in FIGS. 1-5, on a lower portion of the reset button 62. The bottom lip 86 may contact the flexible flange 80 at a point where the flexible flange 80 meets the button outer diameter 112. The contacting surface 88 of the bottom lip 86 applies the force of the actuated reset button 62 to press the reset lever 60, as seen in FIG. 3. The contacting surface 88 may be angled such that the contacting surface 88 aligns and couples with the reset lever 60 to allow for the smooth transfer of force from the reset button 62 to the reset lever 60 as the horizontal base 68 of the reset lever 60 rotates in a generally downward direction, FIG. 3. Further still, the reset feature may alternatively include a switch, a slide, or another suitable mechanical feature for actuating the reset lever 60 in place of, or in addition to, the reset button 62.

As seen in FIG. 8, the gasket 64 in this example includes an annular ring 82 next to and surrounding the circular vertical flexible flange 80 that joins the gasket 64 to the button outer diameter 112. While the flexible flange 80 extends in a vertical direction relative to the base surface of the gasket 64, the annular ring 82 extends below the base surface of the gasket 64 in a generally curved shape extending from an inner edge to an outer edge of the annular ring 82. The annular ring 82 may allow the gasket 64 better flexibility during axial movement of the reset button 62. During depression of the reset button 62, as shown in FIG. 3, the generally curved shape of the annular ring 82 may be altered for the purposes of providing flexion of the gasket 64. As seen in FIG. 3, a portion of the annular ring 82, in this example, straightens to provide the gasket with a range of motion. Furthermore, the spring force produced by the gasket 64 may be increased by the inclusion of the annular ring 82 in the gasket 64. The portion of the annular ring 82 that straightens to allow a modified shape during depression of the reset button 62, as seen in FIG. 3, may provide increased spring force as the annular ring 82 returns to a generally curved shape as shown in FIG. 1.

When the circuit breaker 30 is in the first, contacts-closed position, FIG. 4, a reduced voltage drop across the manually resettable circuit breaker 30 is caused by the closed position of the parallel circuit formed by blade 42 and contacts 44 and 46. The reduction in voltage drop across the manually resettable circuit breaker 30 reduces the current through the parallel lighted status indication circuit 84, FIG. 9, such that the light source 94 is no longer visibly illuminated, even with normal supply voltage applied to terminals 38 and 40.

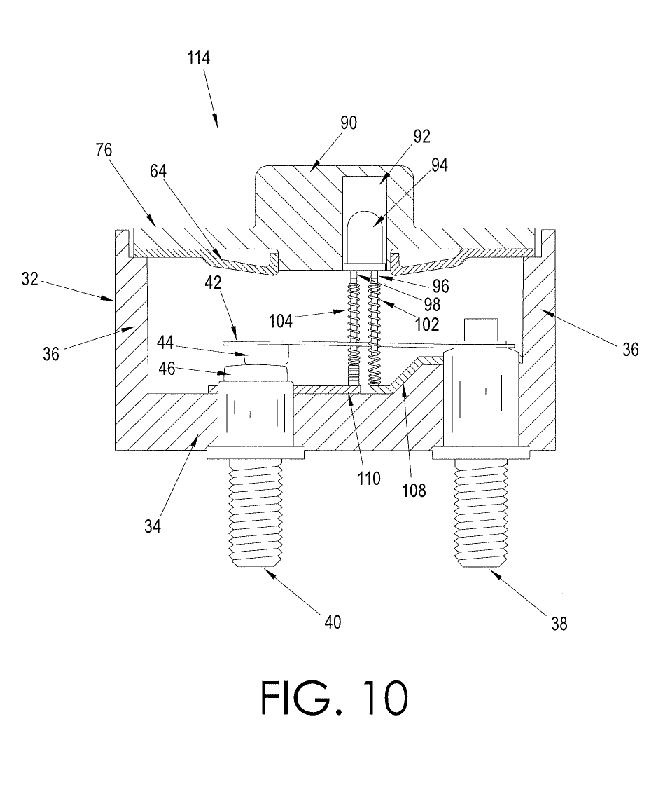

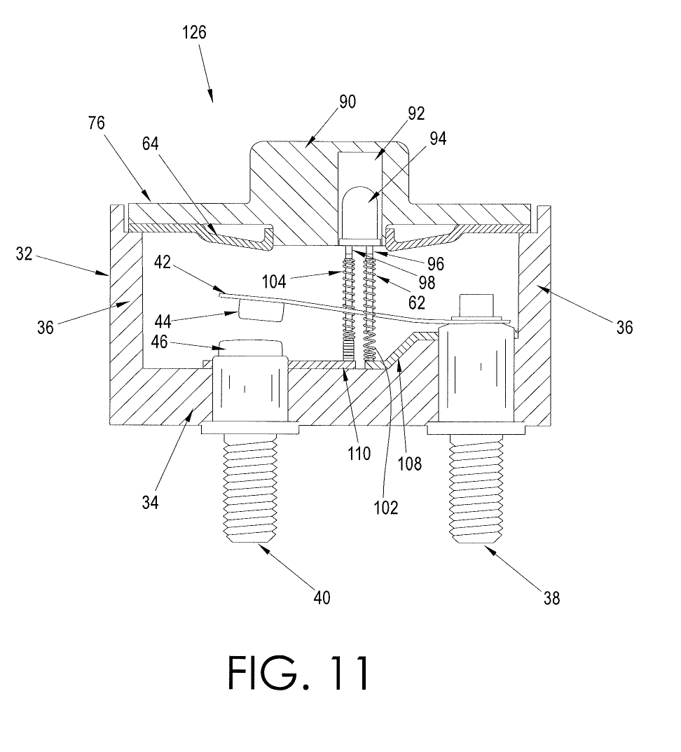

Another example embodiment of an automatic reset circuit breaker 114 is shown in FIGS. 10 and 11. In this example embodiment, the automatic reset circuit breaker 114 may be provided with the lighted status indication circuit 84 as described with reference to FIG. 9. As seen in FIG. 10, the automatic reset circuit breaker 114 having the light status indication circuit 84 is in the closed position. Automatic reset circuit breaker 114 is shown in the open position in FIG. 11. In this embodiment, cover 76 is provided with a raised area. The raised area forms an illumination boss 90 and LED pocket 92. In this embodiment, automatic reset circuit breaker 114 also includes a penetrable gasket such as gasket 64 having hole 78 as described with reference to FIG. 8. The automatic reset circuit breaker 114 of FIG. 10 may provide externally illuminated trip indication using light source 94 such as a bi-directional LED, or another suitable light source. The automatic reset circuit breaker 114, in this embodiment, provides visual indication of the state of the electrical circuit and contacts in a manner similar to the manually resettable circuit breaker 30 of FIG. 4. The light source 94, in this example, is housed within the LED pocket 92 of cover 76. The cover 76 may be formed of a transparent or translucent material that allows light from the light source to be visible through the cover 76 and illumination boss 90. The housing of the light source 94 within the LED pocket 92 is made possible by the throughhole 78 that allows the gasket 64 to be penetrated. Hole 78 allows the light source 94 and leads 96, 98 to penetrate the gasket. Furthermore, housing the light source 94 within the LED pocket 92 in illumination boss 90 of cover 76 allows for visibility of the light source 94. In this example, the light source 94 is in electrical contact with terminals 38 and 40 through an electrical circuit formed by light source leads 96 and 98, springs 102 and 104, and terminal leads 108 and 110 not in direct contact with blade 42, as seen in FIGS. 10 and 11. The electrical circuit formed in the automatic reset circuit breaker 114 in FIGS. 10 and 11 may be the lighted status indication circuit 84 described with reference to FIG. 9. The electrical circuit formed in the automatic reset circuit breaker 114 may further include an additional resistor 112 selectively positionable within the circuit to regulate the current through the light source 94 as described in connection with the lighted status indication circuit 84 of FIG. 9.

The example embodiment of an automatic reset circuit breaker 114, shown in FIGS. 10 and 11, operates in a similar way to the manually resettable circuit breaker 30 described with reference to FIGS. 1 and 4. The automatic reset circuit breaker 114 is shown in FIG. 10 in the first, contacts-closed position. In the first, contacts-closed position, a main circuit is formed by the blade 42 and contacts 44 and 46. The voltage drop across the main circuit with the contacts closed is typically below a level required to cause lighted status indication circuit 84 to illuminate the light source 94. With the contacts 44, 46 closed electrical current through the blade 42 above a predefined level and duration generates heat, which raises the temperature of the blade 42 to a point at which the blade 42 will snap into a configuration having the contacts 44, 46 open as shown in FIG. 11. An increase in voltage drop between the open contacts 44 and 46 in this position allows a small electrical current to pass in either direction between terminals 38 and 40. The voltage drop between the open contacts 44, 46 creates a current through the lighted status indication circuit 84 as shown in FIG. 9. In this example embodiment, the lighted status indication circuit 84 is formed by the electrical coupling of terminal 38, first terminal lead 108, first spring 102, first light source lead 96, light source 94, second light source lead 98, second spring 104, resistor 112, second terminal lead 110, and terminal 40. The electrical current passing through the lighted status indication circuit 84 enables the light source 94 to be visibly illuminated. The visibly illuminated light source 94 housed within the LED pocket 92 of the transparent or translucent illumination boss 90 thereby provides lighted indication of a trip of the automatic reset circuit breaker 114. The light source 94 remains illuminated so long as a sufficient supply voltage is applied to terminals 38 and 40.

As with the manually resettable circuit breaker 30 of FIG. 4, some current always passes through the lighted status indication circuit 84 powering the light source 94, regardless of the open or closed status of the contacts 44, 46 because the lighted status indication circuit 84 is in parallel with the bimetal and contacts circuit. The voltage drop across the open contacts 44, 46 will be dependent on the voltage of the main circuit. In an example, a typical open circuit supply voltage for the main circuit is from approximately 10 V to 50 V. The light source 94 may be visibly illuminated by approximately 15 V of open circuit supply voltage with a current of approximately 0.13 milliamperes through the lighted status indication circuit 84.

As seen, the circuit breakers shown and described herein provide for ease of assembly utilizing components insertable into the circuit breaker embodiments. Further, the circuit breakers are provided with an environmental seal, which, by being both flexible and penetrated by the reset button, allows for lighted trip indication while maintaining a sealed internal compartment.

As many changes could be made in the above constructions without departing from the scope of the disclosure, it is intended that all matter contained in the above description or shown in the accompanying drawings, can be interpreted as illustrative and not in a limiting sense.

### INDUSTRIAL APPLICABILITY

The circuit breaker described herein may provide advantages by improving the environmental seal of the internal compartment. Further, the circuit breaker is configured to include throuhhole(s) that may allow light to exit the cover and indicate the status of the circuit breaker. Further still, the flange and/or annular ring of the gasket may provide greater flexibility for the reset feature and improve the quality and/or duration of the environmental seal.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. It should be understood that the illustrated embodiments are exemplary only, and should not be taken as limiting the scope of the disclosure.

We claim:

1. An electric current responsive circuit breaker device comprising:
a housing formed from electrically insulating material, the housing having an internal compartment and an open end;
a thermostatic snap-action blade;
first and second electrically conductive contacts, the first contact having a stationary position disposed within the internal compartment and the second contact disposed on the thermostatic snap-action blade; and
wherein the first and second contacts are coupled such that electric current flows through the contacts when the temperature of the thermostatic snap-action blade is below a threshold level; and
wherein the thermostatic snap-action blade bends to uncouple the second contact from the first contact when the temperature of the thermostatic snap-action blade is at or above the threshold level, such that electric current does not flow through the first and second contacts after the first and second contacts are uncoupled;
a flexible gasket and a cover, the flexible gasket and the cover interconnectedly arranged with the open end of the housing;
wherein the flexible gasket is arranged between the cover and the housing; and
wherein the gasket has a throughhole disposed on an interior portion thereof.

2. The electric current responsive circuit breaker device according to claim 1, further comprising:
a raised area disposed on an interior part of the cover;
wherein the raised area is vertically aligned with the throughhole.

3. The electric current responsive circuit breaker device according to claim 2, further comprising:
a first flange disposed on an interior part of the gasket; and
wherein the first flange surrounds the throughhole;
an annular ring of flexible gasket material, the annular ring allowing the gasket to move within an axial range relative to the throughhole.

4. The electric current responsive circuit breaker device according to claim 3, further comprising:
a reset feature; the reset feature further comprising:
a reset tab, such that the reset tab retains the thermostatic snap-action blade following the bending of the blade and preserves the uncoupling of the first and second electrical contacts; and
a reset lever, such that the reset lever operates the reset tab to release the thermostatic snap-action blade.

5. The electric current responsive circuit breaker device according to claim 4, the reset feature further comprising:
a reset button;
wherein the reset button is the raised area of the cover;
wherein the reset button is operatively coupled with the flexible gasket; and
wherein the reset button moves axially within the throughhole.

6. The electric current responsive circuit breaker device according to claim 5, wherein the reset button is operatively coupled to the reset lever such that the axial movement of the reset button produces a force on the reset lever that operates the reset tab to release the thermostatic snap-action blade and return the first and second contacts to the coupled configuration thereby coupling the first and second contacts such that electric current flows through the contacts when the temperature of the thermostatic snap-action blade is below the threshold level.

7. The electric current responsive circuit breaker device according to claim 6, the reset feature further comprising:
a leg biased at an acute angle toward the thermostatic snap-action blade and supporting the reset lever;
one or more flexible legs extending downwardly from the reset lever to a distal end and being biased toward the thermostatic snap-action blade, the one or more legs having disposed thereon the reset tab;
one or more laterally disposed legs of the reset lever; and
one or more laterally disposed slots in the housing, the one or more laterally disposed legs configured to support the reset lever within the housing by coupling to the one or more laterally disposed slots.

8. The electric current responsive circuit breaker device according to claim 6, wherein the cover, flexible gasket, and reset button are configured to seal the open end of the housing and protect the first and second contacts and the reset feature from an environment outside the internal compartment.

9. The electric current responsive circuit breaker device according to claim 8, wherein the reset button is optically transmissive, and further comprising:
an light source disposed at least in part within the internal compartment such that the light source illuminates in response to the uncoupling of the first and second contact.

10. The electric current responsive circuit breaker device according to claim 9, wherein light produced by illumination of the light source is transmitted by the throughhole and the reset button such that the light is visible from outside the internal compartment.

11. The electric current responsive circuit breaker device according to claim 10, wherein the light source further comprises:
one or more legs, the one or more legs electrically coupled to one or more of the first and second contacts such that the light source receives power when the thermostatic snap-action blade is bent and the first and second contacts are uncoupled.

12. The electric current responsive circuit breaker device according to claim 11, wherein the reset button has an interior cavity formed therein, and the light source is disposed within the interior cavity of the reset button.

13. The electric current responsive circuit breaker device according to claim 12, wherein the light source further comprises one or more springs electrically coupled with the one or more legs such that the light source moves with the reset button axial to the throughhole, and wherein axial motion of the light source vertically compresses or releases the one or more springs.

14. The electric current responsive circuit breaker device according to claim 13, further comprising one or more light source slots within a sidewall of the housing, and wherein the one or more springs and the one or more legs of the light source are disposed at least partially within the one or more light source slots.

15. A thermally responsive circuit breaker device comprising:
a housing formed from electrically insulating material, the housing having an internal compartment and a bottom wall and a plurality of sidewalls;
first and second electrically conductive contacts;
a thermostatic snap-action blade;
wherein the first electrically conductive contact is disposed on the bottom wall of the housing and the second electrically conductive contact is disposed on the thermostatic snap-action blade;
wherein the blade has first and second positions such that in the first position the first and second contacts are coupled so that electricity is conducted, and in the second position the first and second contacts are uncoupled so that electricity is not conducted; and
wherein the thermostatic snap-action blade is in the first position when the blade has a temperature below a threshold level, and the blade snaps to the second position in response to the temperature rising above the threshold level;
a raised area; and
a flexible gasket having an interior flange;
wherein the interior flange surrounds at least a portion of the raised area and is fixedly attached thereto.

16. The thermally responsive circuit breaker device of claim 15,
wherein the raised area is a reset button for manually resetting the thermostatic snap-action blade to the first position; and further comprising:
a reset lever and a reset tab, configured such that the reset tab holds the thermostatic snap-action blade in the second position until the reset button is manually actuated, the reset lever is operatively coupled to the reset tab and the reset button, and the reset button manipulates the reset lever to allow the reset tab to release the thermostatic blade from the second position such that the blade snaps to the first position.

17. The thermally responsive circuit breaker device of claim 16, further comprising:
a sealing assembly, the sealing assembly further comprising:
a cover; and
a throughhole central to the cover and the flexible gasket, and configured such that the reset button is within the throughhole;
wherein the sealing assembly is arranged such that the reset button is within the throughhole, the flexible gasket is operatively coupled to the reset button, and the cover presses the flexible gasket over an opening opposite the bottom wall in the housing such that the sealing assembly produces a protective seal from an environment outside of the housing;
wherein the gasket has an annular ring of additional material, the radius of the annular ring being larger than the radius of the throughhole; and
wherein the annular ring provides additional flexibility such that the interior gasket flange moves with the reset button in the throughhole and axial thereto.

18. The thermally responsive circuit breaker device of claim 17, wherein the reset button is formed from an optically transmissive material and has formed therein an interior cavity; and further comprising
a light source configured to illuminate when the thermostatic snap-action blade is in the second position, and the light source disposed at least partly within the interior cavity of the reset button.

19. The thermally responsive circuit breaker device of claim 18, further comprising:
at least two springs; and
at least two slots configured to retain the at least to springs;
wherein the at least two springs electrically couple the light source with at least one electrical contact point such that the light source draws power from the at least one electrical contact point in order to illuminate when the thermostatic snap-action blade is in the second position.
